(19) United States
(12) Patent Application Publication
(10) Pub. No.: US 2023/0331621 A1
(43) Pub. Date: Oct. 19, 2023

(54) HIGH MODULUS FIBERGLASS COMPOSITION WITH REDUCED ENERGY CONSUMPTION

(71) Applicant: Owens Corning Intellectual Capital, LLC, Toledo, OH (US)

(72) Inventor: Michelle Korwin-Edson, Granville, OH (US)

(21) Appl. No.: 18/301,334

(22) Filed: Apr. 17, 2023

Related U.S. Application Data
(60) Provisional application No. 63/332,032, filed on Apr. 18, 2022.

(51) Int. Cl. C03C 3/087; C03B 37/012; C03C 13/00

(52) U.S. Cl. CPC C03C 3/087; C03B 37/012; C03C 13/00; C03C 2213/00

(57) ABSTRACT

A glass composition is disclosed that comprises SiO₂ in an amount from 50 to 58% by weight; Al₂O₃ in an amount from 18 to 23% by weight; less than 18% by weight of CaO and MgO; at least 5% by weight of Y₂O₃ and La₂O₃, wherein Y₂O₃ and La₂O₃ are present in a ratio R1 (R1=Y₂O₃/La₂O₃) between 2 and 4. A glass fiber formed from the glass composition has a sonic fiber elastic modulus of at least 94.5 GPa.

### CROSS-REFERENCE TO RELATED APPLICATION(S)

This application claims priority to and any benefit of U.S. Provisional Application No. 63/332,032, filed Apr. 18, 2022, the content of which is incorporated herein by reference in its entirety.

### BACKGROUND OF THE INVENTION

Glass fibers are manufactured from various raw materials combined in specific proportions to yield a desired composition, commonly termed a “glass batch.” This glass batch may be melted in a melting apparatus and the molten glass is drawn into filaments through a bushing or orifice plate (the resultant filaments are also referred to as continuous glass fibers).

As efforts in the glass manufacturing industry move to more environmentally friendly and sustainable manufacturing processes, one major aspect is focused on reducing the energy required to melt glass raw materials used in making the glass fibers. Lowering the temperature required to melt the raw materials will reduce the amount of energy consumed in the manufacturing process overall and can also help extend the life of the melting and bushing apparatus. By reducing the amount of energy consumption, the carbon footprint is ultimately lowered as well.

Additionally, melting conventional raw materials typically results in the release of certain gases such as greenhouse gases (GHGs) into the atmosphere. For example, substantial quantities of carbonate-based raw materials such as limestone and dolomite are typically used to facilitate processing of the material and to impart desirable characteristics to the glass product. The melting of such carbonate-based raw materials, however, may result in the production of GHGs, such as carbon dioxide. The production of GHGs can also result from other processes commonly employed in a conventional glass fiber manufacturing process, such as by the combustion reactions involved in the generation of electricity to provide the energy used to melt the raw materials and also during the fiberization of molten glass.

Thus, as sustainable and environmentally friendly solutions are at the forefront of manufacturing initiatives, there is a need for fiberglass compositions with reduced melt temperatures and that emit less GHGs to the atmosphere during the glass fiber manufacturing process, while maintaining desirable mechanical properties, such as a high elastic modulus and tensile strength.

### SUMMARY OF THE INVENTION

Various exemplary aspects of the present inventive concepts are directed to a glass composition comprising: SiO₂ in an amount from 50 to 58% by weight; Al₂O₃ in an amount from 18 to 23% by weight; less than 18% by weight of CaO and MgO; at least 5% by weight of Y₂O₃ and La₂O₃, wherein Y₂O₃ and La₂O₃ are present in a ratio R1 (R1=Y₂O₃/La₂O₃) between 2 and 4; Li₂O in an amount from 1% (or greater than 1%) by weight to 2% by weight; Na₂O in an amount from 0 to 0.1% by weight; K₂O in an amount from 0 to 0.2% by weight; TiO₂ in an amount from 0 to 0.5% by weight. In any of the exemplary embodiments, the glass composition may have a ratio R2 (R2=SiO₂/(MgO+CaO)) between 3.1 and 3.75, a fiberizing temperature less than 1,300° C., a liquidus temperature no greater than 1,250° C., and/or a ΔT of at least 10° C. A glass fiber formed from the glass composition has a sonic fiber elastic modulus of at least 94.5 GPa.

Further exemplary aspects of the present inventive concepts are directed to a glass fiber formed from a glass composition comprising: SiO₂ in an amount from 50 to 56% by weight; Al₂O₃ in an amount from 18 to 23% by weight; less than 18% by weight of CaO and MgO; Y₂O₃ in an amount from 4.5 to 8% by weight; La₂O₃ in an amount from 0.5 to 4% by weight; wherein Y₂O₃ and La₂O₃ are present in a ratio R1 (R1=Y₂O₃/La₂O₃) between 2 and 4; Na₂O+K₂O in an amount from 0 to 0.5% by weight; and TiO₂ in an amount from 0 to 0.5% by weight. In any of the exemplary embodiments, the glass composition may have a ratio R2 (R2=SiO₂/(MgO+CaO)) between 3.1 and 3.75. The glass fiber may have a density between 2.55 g/cc to 2.8 g/cc and/or a sonic fiber elastic modulus of at least 94.5 GPa.

Further exemplary aspects of the present inventive concepts are directed to a reinforced composite product comprising a polymer matrix and a plurality of glass fibers formed from a glass composition. The glass compositions comprises SiO₂ in an amount from 50 to 58% by weight; Al₂O₃ in an amount from 18 to 23.0% by weight; less than 18% by weight of CaO and MgO; at least 5% by weight of Y₂O₃ and La₂O₃, wherein Y₂O₃ and La₂O₃ are present in a ratio (R1=Y₂O₃/La₂O₃) between 2 and 4; Li₂O in an amount greater than 1% by weight to 2% by weight; Na₂O in an amount from 0 to 0.1% by weight; K₂O in an amount from 0 to 0.2% by weight; TiO₂ in an amount from 0 to 0.5% by weight, wherein the glass composition has a ratio R2 (R2=SiO₂/(MgO+CaO)) between 3.1 and 3.75. The glass composition may have a liquidus temperature no greater than 1,250° C. and a ΔT between 10° C. and 60° C. The glass fiber formed from the glass composition may have a sonic fiber elastic modulus of at least 94.5 GPa.

Yet further exemplary aspects of the present inventive concepts are directed to a glass composition comprising: SiO₂ in an amount from 50 to 58.0% by weight; Al₂O₃ in an amount from 18 to 23% by weight; less than 18% by weight of CaO and MgO; and at least 5% by weight of Y₂O₃ and La₂O₃, wherein Y₂O₃ and La₂O₃ are present in a ratio (R1=Y₂O₃/La₂O₃) between 2 and 4. The glass composition has a fiberizing temperature between 1,200° C. and 1,300° C. and a ΔT of at least 10° C., and wherein a glass fiber formed from the glass composition may have a sonic fiber elastic modulus of at least 94.5 GPa.

The foregoing and other objects, features, and advantages of the invention will appear more fully hereinafter from a consideration of the detailed description that follows.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein. Moreover, any numerical value reported in the Examples may be used to define either an upper or lower end-point of a broader compositional range disclosed herein.

Although the glass composition of the subject inventive concepts may be described and/or claimed in various ways, it should be appreciated the different compositions are alternative solutions to the particular problem addressed herein and are all part of the general inventive concepts disclosed.

The present disclosure relates to a glass composition with a particularly tailored composition to provide glass fibers with a high elastic modulus, low density, and improved temperature profile, such that the glass requires less energy to melt and emits less greenhouse gasses, particularly carbon dioxide, during manufacture. Such glass compositions are particularly beneficial in the field of wind products, such as wind turbines that require longer blades in order to generate more energy. The longer blades require materials with higher elastic modulus in order to withstand forces applied to them without breaking. In fact, the elastic modulus of the glass fibers has a large impact on the end product properties, as even a small improvement in a glass fiber's modulus is multiplied by the overall fiber weight fraction of the composite product providing a large improvement overall.

The glass compositions disclosed herein are suitable for melting in traditional commercially available refractory-lined glass furnaces, which are widely used in the manufacture of glass reinforcement fibers.

The glass composition may be in molten form, obtainable by melting the components of the glass composition in a melter. The glass composition exhibits a low fiberizing temperature, which is defined as the temperature that corresponds to a melt viscosity of about 1000 Poise, as determined by ASTM C965-96(2007). Lowering the fiberizing temperature may reduce the production cost of the glass fibers because it allows for a longer bushing life and reduced energy usage necessary for melting the components of a glass composition. Therefore, the energy expelled is generally less than the energy necessary to melt many commercially available glass formulations, including Advantex® glass. Such lower energy requirements may also lower the overall manufacturing costs associated with the glass composition.

In some exemplary embodiments, the glass composition has a fiberizing temperature of less than 2,372° F. (1,300° C.), including fiberizing temperatures of no greater than 2,354° F. (1,290° C.), no greater than 2,327° F. (1,275° C.), no greater than 2,309° F. (1,265° C.), no greater than 2,291° F. (1,255° C.), no greater than 2,282° F. (1,250° C.), no greater than 2,273° F. (1,245° C.), and no greater than 2,264° F. (1,240° C.). In any of the exemplary embodiments, the glass composition may have a fiberizing temperature between 2,192° F. (1,200° C.) and 2,372° F. (1,300° C.), including between 2,228° F. (1,210° C.) and 2,300° F. (1,260° C.), and between 2,246° F. (1,230° C.) and 2,264° F. (1,240° C.), including all endpoints and subranges therebetween.

Another fiberizing property of a glass composition is the liquidus temperature. The liquidus temperature is defined as the highest temperature at which equilibrium exists between liquid glass and its primary crystalline phase. The liquidus temperature, in some instances, may be measured by exposing the glass composition to a temperature gradient in a platinum-alloy boat for 16 hours (ASTM C829-81(2005)). At all temperatures above the liquidus temperature, the glass is completely molten, i.e., it is free from crystals. At temperatures below the liquidus temperature, crystals may form. It is desirable to have a liquidus temperature as low as possible in order to open the processing window (known as the ΔT, defined in more detail below). A low liquidus temperature also helps reduce crystal formation in the coldest locations of a melting apparatus and thus improves processability of the glass.

In some exemplary embodiments, the glass composition has a liquidus temperature below 2,282° F. (1,250° C.), including a liquidus temperature of no greater than 2,264° F. (1,240° C.), no greater than 2,246° F. (1,230° C.), no greater than 2,237° F. (1,225° C.), no greater than 2,219° F. (1,215° C.), no greater than 2,210° F. (1,210° C.), no greater than 2,201° F. (1,205° C.), no greater than 2,192° F. (1,200° C.), and no greater than 2,183° F. (1,195° C.). In any of the exemplary embodiments, the glass composition may have a liquidus temperature between 2,102° F. (1,150° C.) and 2,282° F. (1,250° C.), including between 2,147° F. (1,175° C.) and 2,255° F. (1,235° C.), and between 2,192° F. (1,180° C.) and 2,192° F. (1,200° C.).

A third fiberizing property is “ΔT”, which is defined as the difference between the fiberizing temperature and the liquidus temperature. The ΔT of the glass composition must be greater than 0 and is particularly selected to provide a glass composition with a sufficient forming window in view of the low fiberizing temperature. In any of the exemplary embodiments, the glass composition has a ΔT of at least 3° C., including at least 10° C., at least 15° C., at least 20° C., at least 24° C., at least 27° F., at least 30° C., at least 33° C., and at least 35° C. In various exemplary embodiments, the glass composition has a ΔT between 3° C. and 80° C., including between 12° C. and 80° C., 15° C. and 60° C., between 20° C. and 55° C., between 25° C. and 50° C., and between 30° C. and 45° C.

To achieve a glass composition capable of producing a high modulus glass with reduced CO₂ emissions, the glass composition includes a reduced concentration of CaO and MgO, collectively. However, generally, it is commonly known that increasing calcium and magnesium levels is an effective way to reduce temperatures, particularly the fiberizing temperature. However, it was surprisingly discovered that the collective CaO and MgO concentrations could be reduced, while also achieving a glass composition with a low fiberizing temperature capable of forming a glass fiber with a sonic fiber elastic modulus of at least GPa, by incorporating a synergetic blend of at least 5.0 wt. % of the rare earth oxides, Y₂O₃ and La₂O₃, collectively.

It has been found that this particular combination and concentration of the rare earth oxides. Y₂O₃ and La₂O₃, helps to reduce the fiberizing temperature, while enabling the production glass fibers with sufficient elastic modulus and tensile strengths. Thus, in any of the exemplary embodiments, the glass composition includes both Y₂O₃ and La₂O₃. Particularly, the subject glass composition includes a total concentration of Y₂O₃ and La₂O₃ of at least 5% by weight, with a ratio of Y₂O₃/La₂O₃(R1) between 2 and 4. In any of the exemplary embodiments, the glass composition includes a Y₂O₃/La₂O₃ ratio (R1) between 2.2 and 3.8, including between 2.4 and 3.6, between 2.6 and 3.4, between 2.8 and 3.2, and between 2.9 and 3.1, including all endpoints and subranges therebetween. Additionally, as mentioned above, the total concentration of Y₂O₃ and La₂O₃ is at least 5% by weight, including, for example, at least 5.5% by weight, at least 5.7% by weight, at least 6% by weight, at least 6.3% by weight, at least 6.5% by weight, at least 6.8% by weight, at least 7% by weight, at least 7.2% by weight, and at least 7.5% by weight. Likewise, the total concentration of Y₂O₃ and La₂O₃ may be no greater than 15% by weight, including, for example, no greater than 9.6% by weight, no greater than 9.4% by weight, no greater than 9.2% by weight, no greater than 9% by weight, no greater than 8.8% by weight, no greater than 8.4% by weight, and no greater than 8% by weight. In any of the exemplary embodiments, the glass composition may include greater than 5% by weight and less than 10% by weight of Y₂O₃ and La₂O₃, collectively, including between 5.5 and 9.8% by weight, between 5.8 and 9.5% by weight, between 6.0 and 9.2% by weight, between 6.3 and 9% by weight, between 6.5 and 8.8% by weight, between 7 and 8.5% by weight, and between 7.2 and 8.2% by weight, including all endpoint and ranges therebetween.

With regard to these oxides individually, the glass composition may include at least 4% by weight Y₂O₃, including, for example, at least 4.2% by weight, 4.4% by weight, 4.6% by weight, at least 4.8% by weight, at least 5% by weight, at least 5.2% by weight, at least 5.5% by weight, at least 5.4% by weight, at least 5.6% by weight, and at least 5.8% by weight. Likewise, the glass composition may include no greater than 8% by weight Y₂O₃, including, for example, no greater than 7.8% by weight, no greater than 7.5% by weight, no greater than 7.3% by weight, no greater than 7% by weight, no greater than 6.8% by weight, no greater than 6.5% by weight, and no greater than 6.3% by weight Y₂O₃. In any of the exemplary embodiments, the glass composition may include greater than 5% by weight to less than 8% by weight Y₂O₃, including between 5.4% by weight to 7.5% by weight, 5.6% by weight to 7% by weight, and 5.8% by weight to 6.7% by weight, including all endpoint and ranges therebetween.

Additionally, the glass composition may include at least 0.5% by weight La₂O₃, including, for example, at least 0.75% by weight, 0.9% by weight, 1% by weight, at least 1.3% by weight, at least 1.5% by weight, at least 1.7% by weight, at least 1.9% by weight, and at least 2% by weight. Likewise, the glass composition may include no greater than 4% by weight La₂O₃, including, for example, no greater than 3.8% by weight, no greater than 3.5% by weight, no greater than 3.3% by weight, no greater than 3% by weight, no greater than 2.8% by weight, no greater than 2.5% by weight, and no greater than 2.3% by weight La₂O₃. In any of the exemplary embodiments, the glass composition may include greater than 1% by weight to less than 4% by weight La₂O₃, including between 1.4 by weight to 3.5% by weight, 1.6% by weight to 3% by weight, and 1.8% by weight to 2.7% by weight, including all endpoint and ranges therebetween.

Including the above-described synergistic blend of Y₂O₃ and La₂O₃ facilitates a reduction in the collective concentration of CaO and MgO, resulting in a lower requirement for the raw materials limestone, dolomites, and magnesite, which are responsible for introducing carbon dioxide into the glass batch. Accordingly, the total concentration of CaO and MgO in the glass composition should be no greater than 18% by weight, such as, for example, no greater than 17.5% by weight, no greater than 17.2% by weight, no greater than 17% by weight, no greater than 16.8% by weight, not greater than 16.5% by weight, no greater than 16.2% by weight, and no greater than 16% by weight. In any of the exemplary embodiments, the glass composition may include both CaO and MgO.

The glass composition further advantageously may include at least 9% by weight and no greater than 13% by weight MgO. In some exemplary embodiments, the glass composition includes at least 9.2% by weight MgO, including, for example, at least 9.5% by weight, at least 9.8% by weight, at least 10% by weight, at least 10.2% by weight, and at least 10.5% by weight MgO. Likewise, in any of the exemplary embodiments, the glass composition may include an MgO concentration that is less than 13% by weight, including an MgO concentration no greater than 12.8% by weight, no greater than 12.6% by weight, no greater than 12.4% by weight, no greater than 12.2, no greater than 12.0% by weight, no greater than 11.8% by weight, and no greater than 11.5% by weight. In any of the exemplary embodiments, the glass composition may comprise an MgO concentration between 9 and less than 13.0% by weight, or between 9.3 and 12.8% by weight, or between 9.5 and 12.5% by weight, or between 9.8 and 12.2% by weight, including any endpoints and subranges therebetween.

As mentioned above, the glass composition includes a reduced concentration of CaO, compared to conventional compositions, which reduces the carbon emissions during manufacturing, while also improving the elastic modulus of formed fibers. Thus, the glass composition may include no greater than 6% by weight CaO, and in some instances, no greater than 5.5% by weight CaO. In any of the exemplary embodiments, the glass composition may include a CaO concentration no greater than 5.2% by weight, including, for example, no greater than 5% by weight, no greater than 4.8% by weight, and no greater than 4.7% by weight CaO. Likewise, any of the exemplary embodiment may include a minimum of 3% by weight CaO, such as, for example, a minimum of 3.2% by weight, 3.5% by weight, 3.7% by weight, 3.9% by weight, and 4.1% by weight. In any of the exemplary embodiments, the glass composition may include between 3 and 6.0% by weight CaO, including between 3.5 and 5.8% by weight, between 3.8 and 5.5% by weight, between 4 and 5.2% by weight, and between 4.1 and less than 5.0% by weight.

The total concentration of MgO and CaO is such that the ratio of SiO₂ to the combined concentrations of MgO and CaO (R2=SiO₂/(CaO+MgO)) may be particularly tailored to between 3.1 and 3.75, including between 3.2 and 3.6, and between 3.3 and 3.55, including all endpoints and subranges therebetween. SiO₂ is the primary glass former (O—Si—O linkages, with 4 oxygens to each silicon and 2 silicons to each oxygen) and the alkaline earth oxides CaO and MgO contribute Ca²⁺ and Mg²⁺ cations to the structure, each of which create two non-bridging oxygens (NBOs) in the glass former linkages. A ratio of SiO₂/(CaO+MgO) above 3.75 would indicate that there are too many bridging oxygens in the structure, which may lead to high viscosity and difficulty in forming due to the high temperatures required to reach the forming viscosity. A ratio of SiO₂/(CaO+MgO) below 3.1 may result in too many NBOs and a very broken or flexible structure, which leads to a low viscosity, along with a low strength and modulus. A balance in the SiO₂/(CaO+MgO) ratio value has been discovered to achieve the desired properties for both forming and application in the market.

The glass composition further includes at least 50% by weight and less than 58% by weight SiO₂. In some exemplary embodiments, the glass composition includes at least 51% by weight SiO₂, including at least 52% by weight, at least 52.5% by weight, at least 53% by weight, at least 53.5% by weight, at least 53.8% by weight, at least 54% by weight, and at least 54.15% by weight. In some exemplary embodiments, the glass composition includes no greater than 60% by weight SiO₂, including no greater than 58% by weight, no greater than 57.5% by weight, no greater than 57% by weight, no greater than 56.5% by weight, no greater than 56% by weight, and no greater than 55.5% by weight. In some exemplary embodiments, the glass composition includes greater than 50% by weight to less than 58% by weight, greater than 52% by weight to less than 57% by weight SiO₂, greater than 53% by weight to less than 56.5% by weight, or between 53.2% by weight and 55.8% by weight, including any endpoints and subranges therebetween.

To achieve both the desired mechanical and fiberizing properties, one important aspect of the glass composition is having a Al₂O₃ concentration of at least 18% by weight and no greater than 23% by weight. Including an Al₂O₃ concentration that is greater than 18% by weight, and particularly of at least 18.5% by weight typically ensures that glass fibers formed from the composition will achieve a sufficient elastic modulus, described in more detail below. Including greater than 23% by weight Al₂O₃ typically causes the glass liquidus to increase to a level above the fiberizing temperature, which results in a negative ΔT.

In any of the exemplary embodiments, the glass composition may include at least 18.8% by weight Al₂O₃, including at least 19% by weight, at least 19.3% by weight, at least 19.5% by weight, at least 19.7% by weight, at least and at least 19.8% by weight, and at least 20% by weight. In some exemplary embodiments, the glass composition includes no greater than 22.8% by weight Al₂O₃, including no greater than 22.5% by weight, no greater than 22% by weight, no greater than 21.7% by weight, no greater than 21.5% by weight, no greater than 21.3% by weight, and no greater than 21% by weight. In some exemplary embodiments, the glass composition includes between 18.6 and 22% by weight Al₂O₃, including between 18.9 and 21.5% by weight Al₂O₃, and between greater than 19% by weight and less than 21% by weight, including any endpoints and subranges therebetween.

In any of the exemplary embodiments, the SiO₂ and Al₂O₃ are present in a ratio R3 (R3=SiO₂/Al₂O₃) that is particularly tailored between 2.5 and 3.0, including between 2.6 and 2.95, and between 2.7 and 2.9, including all endpoints and subranges therebetween. As previous stated, SiO₂ is the primary glass former. However, Al₂O₃ is also a glass former and acts to enhance the degree of connectivity in the glass structure. Thus, there must be sufficient Al₂O₃ present to enhance the connectivity of the glass former network, but not too much Al₂O₃ to where the crystallization of the network becomes too extensive, thereby maintaining a low liquidus temperature. It has been discovered that the ratio of 2.7 to 2.9 is particularly favorable for improving modulus while maintaining an acceptable liquidus temperature.

The glass composition additionally may include at least 1% by weight of the alkali metal oxides Li₂O, Na₂O, and K₂O, (collectively, “R₂O”), while maintaining a total R₂O concentration below 3% by weight. Particularly. Li₂O is an exceptional alkali oxide in that it adds the desirable Li⁺ cation which creates one NBO in the glass structure, thereby lowering the melting and forming viscosity. The glass structure also has a high field strength (or low ionic radius), which allows the glass structure to be topologically closer together (closely packed), which stiffens the network overall. With the effective reduction or removal of Na₂O and K₂O through the use of higher quality raw materials, the amount of Li₂O can be increased to enhance the modulus, while keeping the viscosity from becoming too close to the liquidus temperature.

The glass composition may include Li₂O in an amount that is at least greater than 0.8% by weight, including, for example, at least 0.85% by weight, at least 0.95% by weight, at least 1.05% by weight, at least 1.15% by weight, at least 1.25% by weight, at least 1.4% by weight, and at least 1.5% by weight. Likewise, the glass composition includes less than 3% by weight Li₂O, including, for example, no greater than 2.8% by weight, no greater than 2.5% by weight, no greater than 2.3% by weight, no greater than 2% by weight, no greater than 1.8% by weight, and no greater than 1.6% by weight. In any of the exemplary embodiments, the glass composition may include greater than 0.9% by weight to 2.5% by weight, including between 1.1% by weight and 2.1% by weight, between 1.3% by weight and 1.9% by weight, and between 1.4% by weight and 1.7% by weight, including all endpoint and ranges therebetween.

In some embodiments, the glass composition may be free, or essentially free of Li₂O and/or alkali metal oxides. As used herein, “essentially free” indicates an amount that is less than 1% by weight, such as less than 0.75% by weight, less than 0.5% by weight, less than 0.25% by weight, less than 0.1% by weight, less than 0.05% by weight, or less than 0.025% by weight. Accordingly, in some exemplary embodiments, the glass composition includes less than 0.75% by weight Li₂O, including less than 0.5% by weight, less than 0.3% by weight, less than 0.15% by weight, less than 0.075% by weight, and less than 0.05% by weight Li₂O.

The glass composition may include Na₂O and/or K₂O in individual or collective amounts of at least 0.01% by weight. In some exemplary embodiments, the glass composition includes 0 to 1.0% by weight Na₂O, including 0.01 to 0.5% by weight, 0.03 to 0.4% by weight, and 0.06 to 0.3% by weight, including all endpoint and ranges therebetween. In any of the exemplary embodiments, the glass composition may further include 0 to 1% by weight K₂O, including 0.01 to 0.5% by weight, 0.03 to 0.3% by weight, and 0.04 to 0.15% by weight, including all endpoint and ranges therebetween. In any of the exemplary embodiments, the glass composition may be free of Na₂O and/or K₂O.

The glass composition may further include TiO₂ and/or Fe₂O₃ in individual or collective amounts of at least 0.01% by weight. For instance, in any of the exemplary embodiments, the glass composition may optionally include 0% by weight to 1.5% by weight TiO₂, including 0.01% by weight to 1% by weight, and 0.1 to 0.6% by weight. The glass composition may further optionally include up to 1% by weight Fe₂O₃ . In some exemplary embodiments, the glass composition includes 0% by weight to 0.8% by weight Fe₂O₃ , including 0.01% by weight to 0.6% by weight and 0.1 to 0.35% by weight, including all endpoint and ranges therebetween.

The glass compositions may further include impurities and/or trace materials without adversely affecting the glasses or the fibers. These impurities may enter the glass as raw material impurities or may be products formed by the chemical reaction of the molten glass with furnace components. Non-limiting examples of trace materials include, for example, strontium (SrO), barium (BaO), and combinations thereof. The trace materials may be present in their oxide forms and may further include fluorine and/or chlorine. In some exemplary embodiments, the inventive glass compositions contain no greater than 2% by weight, including, for example, less than 1% by weight, less than 0.5% by weight, less than 0.2% by weight, less than 0.1% by weight, and less than 0.05% by weight of each of BaO, SrO, P₂O₅, ZrO₂, ZnO, and SO₃. In any of the exemplary embodiments, the glass composition may exclude one or more of these compositions.

Accordingly, in any of the exemplary embodiments, the glass composition is free of any one or more of BaO, SrO, P₂O₅, ZrO₂, ZnO, and SO₃.

The glass compositions may be free or essentially free of B₂O₃, although any may be added in small amounts to adjust the fiberizing and finished glass properties and will not adversely impact the properties if maintained below several percent. Accordingly, in any of the exemplary embodiments, the glass composition includes less than 1% by weight B₂O₃, including less than 0.75% by weight, less than 0.5% by weight, less than 0.3% by weight, less than 0.15% by weight, less than 0.075% by weight, and less than 0.05% by weight B₂O₃.

The glass composition may further include fluorine (F) in amounts no greater than 1.0% by weight. For instance, in any of the exemplary embodiments, the glass composition may optionally include 0% by weight to 0.9% by weight F, including 0.01% by weight to 0.75% by weight, and 0.05 to 0.5% by weight, including all endpoint and ranges therebetween.

As used herein, the terms “weight percent,” “% by weight,” “wt. %,” and “percent by weight” may be used interchangeably and are meant to denote the weight percent (or percent by weight) based on the total composition.

Table 1, below, provides various exemplary compositional ranges formulated in accordance with the present inventive concepts.

TABLE 1

| | Exemplary | Exemplary | Exemplary |
|---|---|---|---|
| | Ranges A | Ranges B | Ranges C |
| SiO₂ | 50-58 | 52-56 | 53-55 |
| Al₂O₃ | 18-23 | 18.5-22 | 19-21 |
| CaO | 3-6 | 3.5-5.5 | 4-5 |
| MgO | 9-13 | 9.5-12.5 | 10-11.5 |
| SiO₂/(MgO + CaO) | 3.1-3.7 | 3.2-3.68 | 3.3-3.55 |
| Y₂O₃ | 4-7.5 | 5-7 | 5.5-6.5 |
| La₂O₃ | 0.5-3 | 1-2.5 | 1.3-2.2 |
| Y₂O₃ + La₂O₃ | 5-10 | 6.5-9 | 7.5-8.5 |
| Na₂O + K₂O | 0-1 | 0.01-0.5 | 0.05-0.1 |
| Li₂O | 0-2 | 0.95-1.8 | 1.2-1.65 |
| Fe₂O₃ | 0-0.5 | 0.07-0.3 | 0.09-0.25 |
| F | 0-1 | 0.01-0.75 | 0.05-0.5 |
| TiO₂ | 0-0.6 | 0.01-0.5 | 0.03-0.3 |

As indicated above, the inventive glass compositions unexpectedly demonstrate an optimized elastic modulus, while maintaining desirable forming properties, including fiberizing temperatures below 1,300° C., liquidus temperatures below 1,250° C., (or in some exemplary embodiments, below 1,200° C.), and a positive ΔT value, preferably of at least 10° C.

The fiber tensile strength is also referred herein simply as “strength.” In some exemplary embodiments, the tensile strength is measured on pristine fibers (i.e., unsized and untouched laboratory produced fibers) using an Instron tensile testing apparatus according to ASTM D2343-09. Exemplary glass fibers formed form the inventive glass composition disclosed herein may have a fiber tensile strength of at least 4,400 MPa, including at least 4,450 MPa, at least 4,500 MPa, at least 4,530 MPa, at least 4,550 MPa, at least 4,570 MPa, at least 4,590 MPa, at least 4,600 MPa, at least 4,630 MPa, and at least 4,650 MPa. In some exemplary embodiments, the glass fibers formed from the inventive glass composition have a fiber tensile strength of from 4,450 to 4,900 MPa, including 4500 MPa to 4,800 MPa, 4,550 to 4,750 MPa, including all endpoints and ranges therebetween.

The elastic modulus of a glass fiber may be determined in various ways. In some exemplary embodiments, the elastic modulus is determined by a sonic technique, providing the sonic fiber elastic modulus, by taking the average measurements on five single glass fibers measured in accordance with the sonic measurement procedure outlined in the report “Glass Fiber Drawing and Measuring Facilities at the U.S. Naval Ordnance Laboratory”, Report Number NOLTR 65-87, Jun. 23, 1965. The elastic modulus may further be determined as a bulk modulus, which is performed in accordance with ASTM C1259.

The exemplary glass fibers formed from the inventive glass composition may have a sonic fiber elastic modulus of at least 93 GPa, including at least 93.5 GPa, at least 94.0 GPa, at least 94.5 GPa, at least 95 GPa, at least 95.3 GPa, at least 95.5 GPa, at least 95.8 GPa, or at least 96 GPa. In any of the exemplary embodiments, the exemplary glass fibers formed from the inventive glass composition may have an elastic modulus between 93.5 GPa and 120 GPa, including between 94 GPa and 105 GPa, and between 95 GPa and 100 GPa, including all endpoints and ranges therebetween.

In any of the exemplary embodiments, the glass composition disclosed herein forms glass fibers having a density between 2.2 g/cc to 3.0 g/cc. The density may be measured by any method known and commonly accepted in the art, such as the Archimedes method (ASTM C693-93(2008)) on unannealed bulk glass. In any of the exemplary embodiments, the glass fibers may have a density between 2.3 g/cc to 2.85 g/cc, including from 2.5 g/cc to 2.8 g/cc, 2.55 to 2.75 g/cc, and 2.6 to 2.7 g/cc.

The density and elastic modulus lead to a determination of the specific modulus. It is desirable to have a high specific modulus in order to achieve a lightweight composite material that adds stiffness to the final article. Specific modulus is important in applications where stiffness of the product is an important parameter, such as in wind energy and aerospace applications. As used herein, the specific modulus is calculated by the following equation:

specific modulus(MJ/kg)=Sonic fiber elastic modulus(GPa)/density(kg/cubic meter)

The exemplary glass fibers formed from the inventive glass composition has a specific modulus of 33 MJ/kg to 40 MJ/kg, including 34 MJ/kg to 37 MJ/kg, and 34.5 MJ/kg to 36 MJ/kg. In any of the exemplary embodiments, the glass fibers may have a specific modulus between 34.6 MJ/kg to 35 MJ/kg.

According to some exemplary embodiments, a method is provided for preparing glass fibers from the glass composition described above. The glass fibers may be formed by any means known and traditionally used in the art. In some exemplary embodiments, the glass fibers are formed by obtaining raw ingredients and mixing the ingredients in the appropriate quantities to give the desired weight percentages of the final composition. The method may further include providing the inventive glass composition in molten form and drawing the molten composition through orifices in a bushing to form a glass fiber.

The components of the glass composition may be obtained from suitable ingredients or raw materials including, but not limited to, sand or pyrophyllite for SiO₂, limestone, burnt lime, wollastonite, or dolomite for CaO, kaolin, alumina or pyrophyllite for Al₂O₃, dolomite, dolomitic quicklime, brucite, enstatite, talc, burnt magnesite, or magnesite for MgO, and sodium carbonate, sodium feldspar or sodium sulfate for the Na₂O. In some exemplary embodiments, glass cullet may be used to supply one or more of the needed oxides. As mentioned above, the subject glass composition includes a reduced amount of limestone, dolomite, and magnesite.

The mixed batch may then be melted in a furnace or melter and the resulting molten glass is passed along a forehearth and drawn through the orifices of a bushing located at the bottom of the forehearth to form individual glass filaments. In some exemplary embodiments, the furnace or melter is a traditional refractory melter. By utilizing a refractory tank formed of refractory blocks, manufacturing costs associated with the production of glass fibers produced by the inventive composition may be reduced. In some exemplary embodiments, the bushing is a platinum alloy-based bushing. Strands of glass fibers may then be formed by gathering the individual filaments together. The fiber strands may be wound and further processed in a conventional manner suitable for the intended application.

The operating temperatures of the glass in the melter, forehearth, and bushing may be selected to appropriately adjust the viscosity of the glass, and may be maintained using suitable methods, such as control devices. The temperature at the front end of the melter may be automatically controlled to reduce or eliminate devitrification. The molten glass may then be pulled (drawn) through holes or orifices in the bottom or tip plate of the bushing to form glass fibers. In accordance with some exemplary embodiments, the streams of molten glass flowing through the bushing orifices are attenuated to filaments by winding a strand formed of a plurality of individual filaments on a forming tube mounted on a rotatable collet of a winding machine or chopped at an adaptive speed. The glass fibers of the invention are obtainable by any of the methods described herein, or any known method for forming glass fibers.

The fibers may be further processed in a conventional manner suitable for the intended application. For instance, in some exemplary embodiments, the glass fibers are sized with a sizing composition known to those of skill in the art. The sizing composition is in no way restricted, and may be any sizing composition suitable for application to glass fibers. The sized fibers may be used for reinforcing substrates such as a variety of plastics where the product's end use requires high strength and stiffness and low weight. Such applications include, but are not limited to, nonwoven mats and woven fabrics for use in forming wind turbine blades; infrastructure, such as reinforcing concrete, bridges, etc.; and aerospace structures. Exemplary woven fabrics include, for example, unidirectional, uniaxial, multiaxial, stitched fabric, and the like.

In this regard, some exemplary embodiments of the present invention include a composite material incorporating the inventive glass fibers, as described above, in combination with a hardenable matrix material. This may also be referred to herein as a reinforced composite product. The matrix material may be any suitable thermoplastic or thermoset resin known to those of skill in the art, such as, but not limited to, thermoplastics such as polyesters, polypropylene, polyamide, polyethylene terephthalate, and polybutylene, and thermoset resins such as epoxy resins, unsaturated polyesters, phenolics, vinylesters, and elastomers. These resins may be used alone or in combination. The reinforced composite product may be used for wind turbine blade, rebar, pipe, filament winding, muffler filling, sound absorption, and the like.

In accordance with further exemplary embodiments, the invention provides a method of preparing a composite product as described above. The method may include combining at least one polymer matrix material with a plurality of glass fibers. Both the polymer matrix material and the glass fibers may be as described above.

### EXAMPLES

Exemplary glass compositions according to the present invention were prepared by mixing batch components in proportioned amounts to achieve a final glass composition with the oxide weight percentages set forth in Tables 2, 3, and 4 below.

The raw materials were melted in a platinum crucible in an electrically heated furnace at a temperature of 1,600° C. for 3 hours. The fiberizing temperature was measured using a rotating cylinder method as described in ASTM C965-96(2007), entitled “Standard Practice for Measuring Viscosity of Glass Above the Softening Point,” the contents of which are incorporated by reference herein. The liquidus temperature was measured by exposing glass to a temperature gradient in a platinum-alloy boat for 16 hours, as defined in ASTM C829-81(2005), entitled “Standard Practices for Measurement of Liquidus Temperature of Glass,” the contents of which are incorporated by reference herein. Density was measured by the Archimedes method, as detailed in ASTM C693-93(2008), entitled “Standard Test Method for Density of Glass Buoyancy,” the contents of which are incorporated by reference herein.

The elastic modulus was measured by the sonic fiber technique, in accordance with the measurement procedure outlined in the report “Glass Fiber Drawing and Measuring Facilities at the U.S. Naval Ordnance Laboratory,” Report Number NOLTR 65-87, Jun. 23, 1965. The specific modulus was calculated by dividing the measured elastic modulus in units of GPa by the density in units of kg/m³.

The strength was measured on pristine fibers using an Instron tensile testing apparatus according to ASTM D2343-09 entitled, “Standard Test Method for Tensile Properties of Glass Fiber Strands, Yarns, and Rovings Used in Reinforced Plastics,” the contents of which are incorporated by reference herein.

TABLE 2

| | COMP. | COMP. | COMP. | COMP | | | | | |
|---|---|---|---|---|---|---|---|---|---|
| | EX. 1 | EX. 2 | EX. 3 | EX. 4 | EX. 1 | EX. 2 | EX. 3 | EX. 4 | EX. 5 |
| | (wt. %) | (wt. %) | (wt. %) | (wt. %) | (wt. %) | (wt. %) | (wt. %) | (wt. %) | (wt. %) |
| SiO₂ | 58.8 | 59.9 | 57 | 57 | 55 | 54.76 | 53.75 | 53.69 | 54.18 |
| Al₂O₃ | 17 | 16.54 | 20 | 20 | 20 | 19.98 | 19.99 | 19.98 | 19.88 |
| SiO₂/Al₂O₃ | 3.45 | 3.62 | 2.85 | 2.85 | 2.75 | 2.74 | 2.69 | 2.69 | 2.73 |
| CaO | 5.5 | 5.38 | 4 | 5 | 4.5 | 4.50 | 4.49 | 4.49 | 4.37 |
| MgO | 10.5 | 11.55 | 11 | 10 | 11 | 10.99 | 10.98 | 10.98 | 11.04 |
| CaO + MgO | 16.0 | 16.93 | 15 | 15 | 15.5 | 15.49 | 15.47 | 15.47 | 15.41 |
| SiO₂/ | 3.675 | 3.54 | 3.8 | 3.8 | 3.55 | 3.54 | 3.47 | 3.47 | 3.51 |
| (MgO + CaO) | | | | | | | | | |
| Y₂O₃ | 5 | 4.71 | 4 | 6 | 6 | 6 | 6 | 6 | 6 |
| La₂O₃ | 0.6 | 0 | 2 | 0 | 2 | 2 | 2 | 2 | 2 |
| Na₂O | 0.27 | 0.05 | — | — | — | 0.07 | 0.08 | 0.22 | 0.067 |
| K₂O | 0.48 | 0.1 | — | — | — | 0.06 | 0.16 | 0.25 | 0.123 |
| Li₂O | 0.75 | 1.03 | 2 | 1.8 | 1.5 | 1.50 | 1.50 | 1.50 | 1.52 |
| Fe₂O₃ | 0.43 | 0.24 | — | — | — | 0.07 | 0.28 | 0.21 | 0.245 |
| TiO₂ | 0.41 | 0.5 | — | 0.2 | 0 | 0.02 | 0.59 | 0.51 | 0.567 |
| Y₂O₃/La₂O₃ | 8.33 | N/A | 2 | N/A | 3 | 3 | 3 | 3 | 3 |
| Fiberizing | 1,305 | 1,273 | 1,201 | 1,257 | 1,249 | 1,241 | 1,239 | 1,235 | 1,232 |
| Temperature (° C.) | | | | | | | | | |
| Liquidus | 1,205 | 1,252 | 1,213 | 1,178 | 1,196 | 1,201 | 1,199 | — | 1,192 |
| Temperature (° C.) | | | | | | | | | |
| ΔT (° C.) | 100 | 21 | −12 | 79 | 53.9 | 40 | 40 | — | 40 |
| Density (g/cm³) | 2.66 | 2.65 | 2.74 | 2.67 | 2.7191 | 2.73 | 2.73 | — | 2.73 |
| Sonic Fiber | 90.4 | 93.8 | 98.0 | 94.15 | 94.7 | 95 | 95.1 | 95 | 94.9 |
| Modulus (GPa) | | | | | | | | | |

TABLE 3

| | COMP. | COMP. | COMP. | COMP. | | | | | |
|---|---|---|---|---|---|---|---|---|---|
| | EX. 6 | EX. 7 | EX. 8 | EX. 9 | EX. 6 | EX. 7 | EX. 8 | EX. 9 | EX. 10 |
| | (wt. %) | (wt. %) | (wt. %) | (wt. %) | (wt. %) | (wt. %) | (wt. %) | (wt. %) | (wt. %) |
| SiO₂ | 54.67 | 50.89 | 53.84 | 55.5 | 53.93 | 53.7 | 53 | 53.5 | 55 |
| Al₂O₃ | 22.24 | 22.92 | 18.43 | 21 | 20 | 20 | 22 | 21.5 | 21 |
| SiO₂/Al₂O₃ | 2.45 | 2.22 | 2.92 | 2.64 | 2.7 | 2.69 | 2.41 | 2.49 | 2.62 |
| CaO | 7.99 | 4.47 | 8.29 | 3.5 | 4.5 | 4.5 | 5 | 5 | 4.5 |
| MgO | 9.39 | 12.46 | 10.27 | 11 | 11 | 11 | 12 | 12 | 11 |
| CaO + MgO | 17.38 | 16.93 | 18.56 | 14.5 | 15.5 | 15.5 | 17 | 17 | 15.5 |
| SiO₂/ | 3.14 | 3.01 | 2.74 | 3.83 | 3.48 | 3.46 | 3.12 | 3.14 | 3.54 |
| (MgO + CaO) | | | | | | | | | |
| Y₂O₃ | 5 | 5.49 | 3 | 4 | 6 | 6 | 4 | 4 | 5 |
| La₂O₃ | 0 | 1.5 | 3 | 3 | 2 | 2 | 2 | 2 | 2 |
| Na₂O | 0.5 | 0.034 | 0.12 | 0 | 0.04 | 0.07 | — | — | — |
| K₂O | 0 | 0.01 | 0.12 | 0 | 0.15 | 0.26 | — | — | — |
| Li₂O | 0 | 2.2 | 2 | 2 | 1.5 | 1.5 | 2 | 2 | 1.5 |
| Fe₂O₃ | 0.16 | 0.012 | 0.32 | 0 | 0.283 | 0.3 | — | — | — |
| TiO₂ | 0.03 | 0.009 | 0.64 | 0 | 0.592 | 0.6 | — | — | 0 |
| Y₂O₃/La₂O₃ | N/A | 3.66 | 1 | 1.33 | 3 | 3 | 2 | 2 | 2.5 |
| Fiberizing | — | 1,200.6 | 1,196.1 | 1,200.6 | 1,239 | 1,230 | 1,206 | 1,208 | 1,253 |
| Temperature | | | | | | | | | |
| (° C.) | | | | | | | | | |
| Liquidus | 1,267 | 1,213.9 | 1,173.3 | 1,213.9 | 1,199 | | 1,191 | 1,188 | 1,227 |
| Temperature | | | | | | | | | |
| (° C.) | | | | | | | | | |
| ΔT (° C.) | — | −13.3 | 22.8 | −13.3 | 39.6 | | 15 | 20 | 26 |
| Density | 2.69 | 2.744 | 2.732 | 2.744 | 2.7333 | 2.7262 | 2.71 | 2.71 | 2.70 |
| (g/cm³) | | | | | | | | | |
| Sonic Fiber | 91.3 | 98 | 94.1 | 98 | 95.0 | 95.1 | 96.2 | 96.2 | 94.7 |
| Modulus (GPa) | | | | | | | | | |

TABLE 4

| | EX. 11 | EX. 12 | EX. 13 | EX. 14 | EX. 15 | EX. 16 |
|---|---|---|---|---|---|---|
| | (wt. %) | (wt. %) | (wt. %) | (wt. %) | (wt. %) | (wt. %) |
| SiO₂ | 52.5 | 54 | 54 | 53.8 | 54 | 54.1 |
| Al₂O₃ | 22.5 | 20.2 | 20.2 | 20.2 | 20.2 | 20.5 |
| SiO₂/Al₂O₃ | 2.7 | 2.7 | 2.7 | 2.67 | 2.7 | 2.64 |
| CaO | 4.5 | 4.5 | 4.5 | 4.5 | 4.5 | 5 |
| MgO | 12.5 | 11.1 | 11.1 | 11.1 | 11.1 | 11.1 |
| CaO + MgO | 17 | 15.6 | 15.6 | 15.6 | 15.6 | 15.6 |
| SiO₂/ | 3.1 | 3.5 | 3.5 | 3.4 | 3.5 | 3.5 |
| (MgO + CaO) | | | | | | |
| Y₂O₃ | 4 | 6 | 6 | 6.5 | 6.5 | 6 |
| La₂O₃ | 2 | 2 | 2 | 2.5 | 2.5 | 2 |
| Na₂O | — | 0.2 | 0.2 | 0.1 | 0.1 | 0.1 |
| ZrO2 | — | 0.5 | 1 | — | — | — |
| K₂O | — | — | — | 0.2 | 0.2 | 0.1 |
| Li₂O | 2 | 1 | 0.5 | 1 | 0.8 | 1 |
| Fe₂O₃ | — | 0.15 | 0.15 | 0.05 | 0.05 | 0.05 |
| TiO₂ | — | 0.35 | 0.35 | 0.05 | 0.05 | 0.05 |
| Y₂O₃/La₂O₃ | 2 | 3 | 3 | 2.6 | 2.6 | 3 |
| Fiberizing | 1,208.3 | 1,251.7 | 1269.4 | 1254.4 | 1261.9 | 1254.7 |
| Temperature | | | | | | |
| (° C.) | | | | | | |
| Liquidus | 1,204.2 | 1,226.9 | 1,242.2 | 1231.1 | 1245 | 1235 |
| Temperature | | | | | | |
| (° C.) | | | | | | |
| ΔT (° C.) | 4.1 | 24.8 | 27.2 | 23.3 | 16.9 | 19.7 |
| Density (g/cm³) | 2.72 | 2.74 | 2.75 | 2.75 | 2.75 | 2.73 |
| Sonic Fiber | 96.64 | 95.0 | 94.8 | 94.7 | 94.5 | 94.7 |
| Modulus (GPa) | | | | | | |

Tables 2, 3 and 4 illustrate the challenge the subject glass composition overcame to achieve a glass with particularly balanced forming properties (i.e, a fiberizing temperature below 1,300° C., a liquidus temperature no greater than 1,250° C. (and preferably no greater than 1,200° C.), and a positive delta T (preferably a delta T of at least 10° C.), with an improved sonic fiber elastic modulus that is at least 94.5 GPa, over prior art high-performance glass (Comparative Examples). The Comparative prior art glass compositions are unable to achieve each of these parameters in a single glass composition and thus an important technical effect has been identified within the particular glass composition described herein. As provided above, even an apparently minor increase in a fiber's elastic modulus can have a large impact on the properties of a composite product formed therewith, due to multiplying the increase over the entire fiber weight fraction of the product.

Particularly, as illustrated in Table 2, Comparative Examples 1, 2, and 4 each fall outside of at least two required parameters (i.e., high silica, low alumina, low lanthanum, and low lithium (comparative example 1 only)) and are unable to achieve an elastic modulus of at least 94.5 GPa. Comparative Examples 3 and 4 include an SiO₂/(MgO+CaO) concentration above 3.75 and this distinction results in a negative ΔT in Comparative Example 3 and a low elastic modulus in Comparative Example 4. In Table 3, Comparative Examples 6 and 8 demonstrate a low elastic modulus and both comparative glass compositions include a Y₂O₃/La₂O₃ ratio outside the required ratio of 2.0 and 4.0, amongst other differences. Comparative Examples 7 and 8 each include an SiO₂/(MgO+CaO) ratio outside the required ratio of 3.1 to 3.75, resulting in a negative ΔT value, which is unacceptable for processing. In contrast, each of Examples 1 to 16 fall within the particular requirements and relationships set forth herein and produce glass compositions having fiberizing temperatures below 1,300° C., liquidus temperatures no greater than 1,250° C., and positive delta T values (preferably of at least 10° C.), while also producing glass fibers having sonic fiber elastic modulus values of at least 94.5 GPa.

Paragraph 1. A glass composition comprising: SiO₂ in an amount from 50.0 to 58.0% by weight; Al₂O₃ in an amount from 18.0 to 23.0% by weight; less than 18.0% by weight of CaO and MgO; at least 5.0% by weight of Y₂O₃ and La₂O₃, wherein Y₂O₃ and La₂O₃ are present in a ratio R1 (R1=Y₂O₃/La₂O₃) between 2.0 and 4.0; Li₂O in an amount greater than 1.0% by weight to 2.0% by weight; Na₂O in an amount from 0.0 to 0.1% by weight; K₂O in an amount from 0.0 to 0.2% by weight; TiO₂ in an amount from 0.0 to 0.5% by weight, wherein the glass composition has a ratio R2 (R2=SiO₂/(MgO+CaO)) between 3.1 and 3.75, wherein the glass composition has a fiberizing temperature less than 1,300° C., a liquidus temperature no greater than 1,250° C., and a ΔT of at least 10° C., and wherein a glass fiber formed from the glass composition has a sonic fiber elastic modulus of at least 94.5 GPa.

Paragraph 2. The glass composition of paragraph 1, wherein the composition includes 4.0 to 8.0% by weight Y₂O₃ and 0.5 to 4.0% by weight La₂O₃.

Paragraph 3. The glass composition according to any one of paragraphs 1 and 2, wherein the composition includes no greater than 17.0% by weight CaO and MgO.

Paragraph 4. The energy efficient high performance glass composition according to any one of paragraphs 1 to 3, wherein the composition comprises 18.3 to 21.5% by weight Al₂O₃.

Paragraph 5. The glass composition according to any one of paragraphs 1 to 4, wherein the composition is essentially free of B₂O₃.

Paragraph 6. The glass composition according to any one of paragraphs 1 to 5, wherein the composition comprises 1.25% by weight to less than 2.0% by weight Li₂O.

Paragraph 7. The glass composition according to any one of paragraphs 1 to 6, wherein the composition has a fiberizing temperature less than 1,270° C.

Paragraph 8. The glass composition according to any one of paragraphs 1 to 7, wherein the composition has a fiberizing temperature less than 1,250° C.

Paragraph 9. The glass composition according to any of paragraphs 1 to 8, wherein the composition has a ratio R3 (R3=SiO₂/Al₂O₃) between 2.5 and 3.0.

Paragraph 10. The glass composition according to any of paragraphs 1 to 9, wherein the composition has a ratio R1 between 2.8 and 3.1.

Paragraph 11. The glass composition according to any of claims 1 to 10, wherein the composition further includes up to 1.0 wt. % fluorine.

Paragraph 12. A glass fiber formed from a glass composition comprising: SiO₂ in an amount from 50.0 to 56.0% by weight; Al₂O₃ in an amount from 18.0 to 23.0% by weight; less than 18.0% by weight of CaO and MgO; Y₂O₃ in an amount from 4.5 to 8.0% by weight; La₂O₃ in an amount from 0.5 to 4.0% by weight; wherein Y₂O₃ and La₂O₃ are present in a ratio R1 (R1=Y₂O₃/La₂O₃) between 2.0 and 4.0; Na₂O+K₂O in an amount from 0.0 to 0.5% by weight; TiO₂ in an amount from 0.0 to 0.5% by weight, wherein the glass composition has a ratio R2 (R2=SiO₂/(MgO+CaO)) between 3.1 and 3.75, wherein the glass fiber has a density between 2.55 g/cc to 2.8 g/cc and a sonic fiber elastic modulus of at least 94.5 GPa.

Paragraph 13. The glass fiber according to paragraph 12, wherein the glass composition comprises 18.5 to 21.5% by weight Al₂O₃.

Paragraph 14. The glass fiber according to any one of paragraphs 12 to 13, wherein the glass composition includes a ratio R3 (R3=SiO₂/Al₂O₃) between 2.5 and 3.0.

Paragraph 15. The glass fiber according to any one of paragraphs 12 to 14, wherein the composition comprises 0.5 to 2.0% by weight Li₂O.

Paragraph 16. The glass fiber according to any one of paragraphs 12 to 15, wherein the composition includes a total amount of Y₂O₃ and La₂O₃ that is greater than 7.0% by weight.

Paragraph 17. A method of forming a continuous glass fiber comprising: providing a molten composition according to any one of paragraphs 1 to 11; and drawing the molten composition through an orifice to form a continuous glass fiber.

Paragraph 18. A reinforced composite product comprising a polymer matrix; and a plurality of glass fibers formed from a glass composition. The glass compositions comprises SiO₂ in an amount from 50.0 to 58.0% by weight; Al₂O₃ in an amount from 18.0 to 23.0% by weight; less than 18.0% by weight of CaO and MgO; at least 5.0% by weight of Y₂O₃ and La₂O₃, wherein Y₂O₃ and La₂O₃ are present in a ratio (R1=Y₂O₃/La₂O₃) between 2.0 and 4.0; Li₂O in an amount greater than 1.0% by weight to 2.0% by weight; Na₂O in an amount from 0.0 to 0.1% by weight; K₂O in an amount from 0.0 to 0.2% by weight; TiO₂ in an amount from 0.0 to 0.5% by weight, wherein the glass composition has a ratio R2 (R2=SiO₂/(MgO+CaO)) between 3.1 and 3.75, wherein the glass composition has a liquidus temperature no greater than 1,250° C. and a ΔT between 10° C. and 60° C., and wherein a glass fiber formed from the glass composition has a sonic fiber elastic modulus of at least 94.5 GPa.

Paragraph 19. A reinforced composite product according to paragraph 18, wherein the reinforced composite product is in the form of a wind turbine blade.

Paragraph 20. The reinforced composite product according to any one of paragraphs 18 and 19, wherein the composition includes 4.0 to 8.0% by weight Y₂O₃ and 0.5 to 4.0% by weight La₂O₃.

Paragraph 21. The reinforced composite product according to any one of claims 18 to 20, wherein the composition includes no greater than 17.0% by weight CaO and MgO.

Paragraph 22. The reinforced composite product according to any one of claims 18 to 21, wherein the composition comprises 18.3 to 21.5% by weight Al₂O₃.

Paragraph 23. The reinforced composite product according to any one of claims 18 to 22, wherein the composition comprises 1.25% by weight to less than 2.0% by weight Li₂O.

Paragraph 24. The reinforced composite product according to any one of paragraphs 18 to 23, wherein the composition has a fiberizing temperature less than 1,270° C.

Paragraph 25. The reinforced composite product according to any one of paragraphs 18 to 24, wherein the composition has a ratio R3 (R3=SiO₂/Al₂O₃) between 2.5 and 3.0.

Paragraph 26. The reinforced composite product according to any one of paragraphs 18 to 25, wherein the composition has a ratio R1 between 2.8 and 3.1.

Paragraph 27. A glass composition comprising: SiO₂ in an amount from 50.0 to 58.0% by weight; Al₂O₃ in an amount from 18.0 to 23.0% by weight; less than 18.0% by weight of CaO and MgO; and at least 5.0% by weight of Y₂O₃ and La₂O₃, wherein Y₂O₃ and La₂O₃ are present in a ratio (R1=Y₂O₃/La₂O₃) between 2.0 and 4.0; wherein the glass composition has a fiberizing temperature between 1,200° C. and 1,300° C. and a ΔT of at least 10° C., and wherein a glass fiber formed from the glass composition has a sonic fiber elastic modulus of at least 94.5 GPa.

Paragraph 28. The glass composition of paragraph 27, wherein the glass composition includes a ratio R2 (R2=SiO₂/(MgO+CaO)) between 3.1 and 3.75.

Paragraph 29. The high performance glass composition of either paragraph 27 or paragraph 28, wherein the glass composition has a liquidus temperature between 1,150° C. and 1,250° C.

Paragraph 30. The high performance glass composition of any one of paragraphs 27 to 29, wherein the glass composition has a fiberizing temperature between 1,210° C. and 1,260° C.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A glass composition comprising:
SiO₂ in an amount from 50 to 58% by weight;
Al₂O₃ in an amount from 18 to 23% by weight;
less than 18% by weight of CaO and MgO;
at least 5% by weight of Y₂O₃ and La₂O₃, wherein Y₂O₃ and La₂O₃ are present in a ratio R1 (R1=Y₂O₃/La₂O₃) between 2 and 4;
Li₂O in an amount greater than 1% by weight to 2% by weight;
Na₂O in an amount from 0 to 0.1% by weight;
K₂O in an amount from 0 to 0.2% by weight; and
TiO₂ in an amount from 0 to 0.5% by weight,
wherein the glass composition has a ratio R2 (R2=SiO₂/(MgO+CaO)) between 3.1 and 3.75,
wherein the glass composition has a fiberizing temperature less than 1,300° C., a liquidus temperature no greater than 1,250° C., and a ΔT of at least 10° C., and
wherein a glass fiber formed from the glass composition has a sonic fiber elastic modulus of at least 94.5 GPa.

2. The glass composition of claim 1, wherein the composition includes 4 to 8% by weight Y₂O₃ and 0.5 to 4% by weight La₂O₃.

3. The glass composition according to claim 1, wherein the composition comprises 18.3 to 21.5% by weight Al₂O₃.

4. The glass composition according to claim 1, wherein the composition is essentially free of B₂O₃.

5. The glass composition according to claim 1, wherein the composition comprises 1.25% by weight to less than 2% by weight Li₂O.

6. The glass composition according to claim 1, wherein the composition has a fiberizing temperature less than 1,250° C.

7. The glass composition according to claim 1, wherein the composition has a ratio R3 (R3=SiO₂/Al₂O₃) between 2.5 and 3.

8. The glass composition according to claim 1, wherein the composition has a ratio R1 between 2.8 and 3.1.

9. A glass fiber formed from a glass composition comprising:
SiO₂ in an amount from 50 to 56% by weight;
Al₂O₃ in an amount from 18 to 23% by weight;
less than 18.0% by weight of CaO and MgO;
Y₂O₃ in an amount from 4.5 to 8% by weight;
La₂O₃ in an amount from 0.5 to 4% by weight;
wherein Y₂O₃ and La₂O₃ are present in a ratio R1 (R1=Y₂O₃/La₂O₃) between 2 and 4;
Na₂O+K₂O in an amount from 0 to 0.5% by weight; and
TiO₂ in an amount from 0 to 0.5% by weight,
wherein the glass composition has a ratio R2 (R2=SiO₂/(MgO+CaO)) between 3.1 and 3.75, wherein the glass fiber has a density between 2.55 g/cc to 2.8 g/cc and a sonic fiber elastic modulus of at least 94.5 GPa.

10. The glass fiber according to claim 9, wherein the glass composition comprises 18.5 to 21.5% by weight Al₂O₃.

11. The glass fiber according to claim 9, wherein the glass composition includes a ratio R3 (R3=SiO₂/Al₂O₃) between 2.5 and 3.

12. The glass fiber according to claim 9, wherein the composition includes a total amount of Y₂O₃ and La₂O₃ that is greater than 7% by weight.

13. A method of forming a continuous glass fiber comprising:
providing a molten composition according to claim 1; and
drawing the molten composition through an orifice to form a continuous glass fiber.

14. A reinforced composite product comprising;
a polymer matrix; and
a plurality of glass fibers formed from a glass composition according to claim 1.

15. A reinforced composite product according to claim 14, wherein the reinforced composite product is in the form of a wind turbine blade.

16. The reinforced composite product according to claim 14, wherein the composition includes 4 to 8% by weight Y₂O₃ and 0.5 to 4% by weight La₂O₃.

17. A glass composition comprising:
SiO₂ in an amount from 50 to 58% by weight;
Al₂O₃ in an amount from 18 to 23% by weight;
less than 18% by weight of CaO and MgO; and
at least 5% by weight of Y₂O₃ and La₂O₃, wherein Y₂O₃ and La₂O₃ are present in a ratio (R1=Y₂O₃/La₂O₃) between 2 and 4;
wherein the glass composition has a fiberizing temperature between 1,200° C. and 1,300° C. and a ΔT of at least 10° C., and
wherein a glass fiber formed from the glass composition has a sonic fiber elastic modulus of at least 94.5 GPa.

18. The glass composition of claim 17, wherein the glass composition includes a ratio R2 (R2=SiO₂/(MgO+CaO)) between 3.1 and 3.75.

19. The glass composition of claim 17, wherein the glass composition has a liquidus temperature between 1,150° C. and 1,250° C.

20. The glass composition of claim 17, wherein the glass composition has a fiberizing temperature between 1,210° C. and 1,260° C.
